(19) United States
(12) Patent Application Publication
(10) Pub. No.: US 2007/0266583 A1
(43) Pub. Date: Nov. 22, 2007

(54) Flat lay-out tape

(76) Inventor: Brady M. Furrow, Roanoke, VA (US)

Correspondence Address: SETO PATENTS, 406 RIVERLAND DR., SALEM, VA, 24153, US

(21) Appl. No.: 11/595,746

(22) Filed: Nov. 10, 2006

Related U.S. Application Data
(60) Provisional application No. 60/801,937, filed on May 22, 2006.

(51) Int. Cl. G01D 21/00

(52) U.S. Cl. 33/648

(57) ABSTRACT

A flat lay-out tape for roofers that eliminates errors and saves time in striking chalk lines for aligning rows of shingles. The flat design allows the tape to lay flush against the roof surface, which facilitates accurate measuring and striking. The lay-out tape prevents errors by providing row indicators for different shingles on different sides of the tape. In the preferred embodiment, row indicators for standard shingles are shown on one side of the tape, and row indicators for architectural shingles are provided on the other side. Standard measuring tape markings can also be provided on either side of the tape. In operation, the terminal end of a lay-out tape is tacked down near the bottom of a roof, near a side edge of the roof, and the tape is extended over the apex of the roof. The same is done with a second lay-out tape, near the opposite side edge of the roof. A chalk line is then stretched, and struck, between corresponding indicators of the two lay-out tapes. The present invention drastically reduces the number of manual markings needed on a typical roof, from hundreds down to four.

### BACKGROUND OF THE INVENTION

The present invention was originally disclosed in U.S. provisional patent application Ser. No. 60/801,937 filed on May 22, 2006, and priority is claimed to the provisional patent application.

The present invention relates generally to the field of roofing equipment and more specifically to a lay-out tape that assists in laying out straight rows of shingles.

The majority of residential houses have shingle roofs. Shingles are relatively small weather resistant pieces of material that are attached, in an overlapping pattern, to the tops of houses to provide protection from the elements. The two most popular styles of roofing shingles are standard and architectural shingles. Rows of standard shingles are spaced 5 inches apart, while rows of architectural shingles are spaced 5 ½ inches apart. The traditional method of pre-marking rows of shingles involves the use of a standard measuring tape. The measuring tape is stretched from the bottom of the roof, to the top of the roof, and marks are manually made on the roof surface every 5 ½ inches, for architectural shingles. This process is repeated on the opposite end of the roof and chalk lines are struck between corresponding marks to create guidelines for the rows of shingles. This traditional method however has many problems. Continually adding 5 ½ to a previous number to come up with the next marking position on the measuring tape is difficult, even for roofers that are good with numbers, and erroneous marks are not uncommon. Also, manually placing the large number of required marks on both sides of a roof is very time consuming. Further, standard measuring tapes are beveled and do not lay flush against a roof, thereby making precise marks difficult to achieve. Beveled tapes also tend to slide easily on flat surfaces such as a roof thereby adding to the difficulties. To make matters worse, a standard measuring tape only has an “L” shaped hook for attaching to a starting point and the hook does not allow the tape to remain securely out-stretched for longer than a few seconds.

What is needed in the field is a lay-out tape that is specifically designed for laying out rows of shingles on a roof. The ideal tape would have a flat surface so that it could lay flush with the roof surface and allow for precise striking of chalk lines. The ideal tape would also have an eyelet at, or near, the end of the tape, so the end could be tacked down and remain securely in place the entire time chalk lines were being struck, which totally eliminates the need to make alignment marks on the roof surface. Furthermore, an ideal shingle lay-out tape would have easy to read indicia on the top side of the tape for architectural shingles, and markings for standard shingles on the back side of the tape, so that confusion about which mark to follow would be eliminated. Using two such lay-out tapes would allow for quick and accurate striking of horizontal chalk lines, for the rows of shingles, and eliminate the time consuming and error prone requirement of manually making marks on the roof surface. Such a device would not only save time, but also provide more accurate chalk (lay-out) lines for the rows of shingles.

### SUMMARY OF THE INVENTION

A dual sided, flat, lay-out tape that assists roofers in laying out rows of shingles on a roof. The lay-out tape saves time by eliminating the need for hundreds of manual markings on the roof, and eliminates most marking errors by having only one set of indicators on any one side of the tape. The dual sided, flat, lay-out tape comprises a housing and a flat ribbon that is rolled in a coil while inside the housing. The housing has a tough, durable exterior that protects the ribbon and other items stored in the interior of the housing. The housing includes a slotted opening, for passage of the ribbon, and at least part of the ribbon's rewind mechanism. The ribbon has a first side that includes row indicator markings for a first type of roofing shingle, and a second side that includes row indicator markings for a second type of roofing shingle. Each set of indicator markings includes a “start” marking and can be used by the roofer to strike chalk lines on the roof for row alignment purposes. The interior end of the ribbon is attached to the rewind mechanism and the exterior end of the ribbon at least partially extends outside of the slotted opening in the housing. In the preferred embodiment, an eyelet is attached to the exterior end of the ribbon for tacking the ribbon to the roof. The first side of the ribbon further preferably includes standard measuring tape indicator markings, starting at the exterior end and extending at least two inches up the length of the ribbon. The first type of roofing shingles can be any type, such as architectural shingles, and the second type of shingles can be any other type, such as standard shingles. The rewind mechanism is preferably an automatic mechanism that allows the ribbon to be recoiled with minimal effort from the roofer. Of course, a ribbon locking mechanism is provided to lock the ribbon in place after it has been extended the desired distance. The housing is preferably made of a hard plastic material and the ribbon made from a durable material, such as fiberglass.

It is an object of the present invention to drastically reduce the amount of time required to make lay-out lines for rows of shingle by eliminating the need for hundreds of manual markings.

It is another object of the present invention to eliminate erroneous lay-out lines by providing only one type of indicators on any one side of the present tape.

It is yet another object of the present invention to provide a lay-out tape that lays flush against any flat surface so that accurate line striking is achievable.

It is still a further object of the present invention to provide a durable lay-out tape that can be used over and over.

### BRIEF DESCRIPTION OF THE DRAWINGS

The invention of the present application will be described in detail with reference to the accompanying drawing(s), given only by way of example, in which:

FIG. 1 is a side view of the preferred embodiment;

FIG. 2 is a side view of an alternative embodiment;

FIG. 3 is a top view of the architectural side of the preferred embodiment;

FIG. 4 is a top view of the standard side of the preferred embodiment;

FIG. 5 is a top view of the architectural side of another alternative embodiment;

FIG. 6 is a top view of the architectural side of yet another alternative embodiment; and, FIG. 7 shows two of the preferred lay-out tapes in operation.

### DETAILED DESCRIPTION OF THE INVENTION

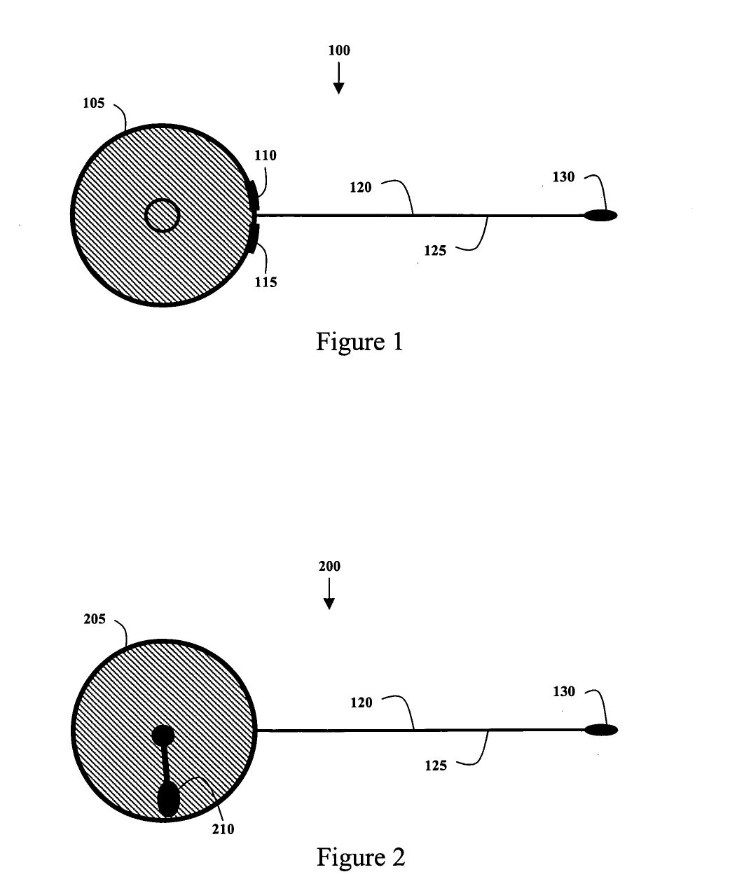

FIG. 1 is a side view of the preferred embodiment 100 of the present flat lay-out tape. The tape 120 & 125 is preferably made of a resilient material, such as fiberglass and metal, that allows the tape to be durable and have a long useful life. The case 105 is also made of a durable material, such as a hard plastic, that is able to protect the invention from an advertent drop from a rooftop. A first set of indicator markings are provided on the top 120 of the tape, and a second set of indicator markings are provided on the back side 125 of the tape. The tape 120 & 125 is flat, and not beveled as are many measuring tapes, so the tape will lay flush with the roof surface. This allows roofers to hold a chalk line accurately to the indicator marks on the tape during the chalk line striking process and eliminates the need for making marks directly on the roof. Initially, the tape is coiled up inside of its case 105 and an eyelet 130 that is attached to the beginning end of the tape is all that is exposed. The roofer pulls out a desired length of the lay-out tape by pulling on the eyelet 130. The case 105 preferably includes a rewind coil that is attached to the interior end of the-tape. The rewind coil is tightened as the tape is pulled from the case 105 and provides a self-retracting feature to this embodiment 100. Self-retracting tapes are well-known in the art and further discussion of their mechanism is not required to understand the present invention. Sliding stop-lock 110 is provided on the case, above the exit area of the tape, to lock the tape in place and prevent retraction, when the roofer is using the architectural side 120 of the tape. Sliding stop-lock 115 is also provided to lock out the desired length of tape when the roofer is using the standard side of the tape.

FIG. 2 shows an alternative embodiment 200 of the present lay-out tape. The main features of the lay-out tape, such as the use of a flat, vice beveled, tape and indicators markings for different shingles on different sides 120 & 125 of the tape, are still present in this alternative embodiment 200. Also, an eyelet 130 is provided to secure the beginning end of the tape to the roof. However, in this embodiment 200, after the roofer has finished using the tape, the roofer uses a handle 210 to wind the tape back into the case 105.

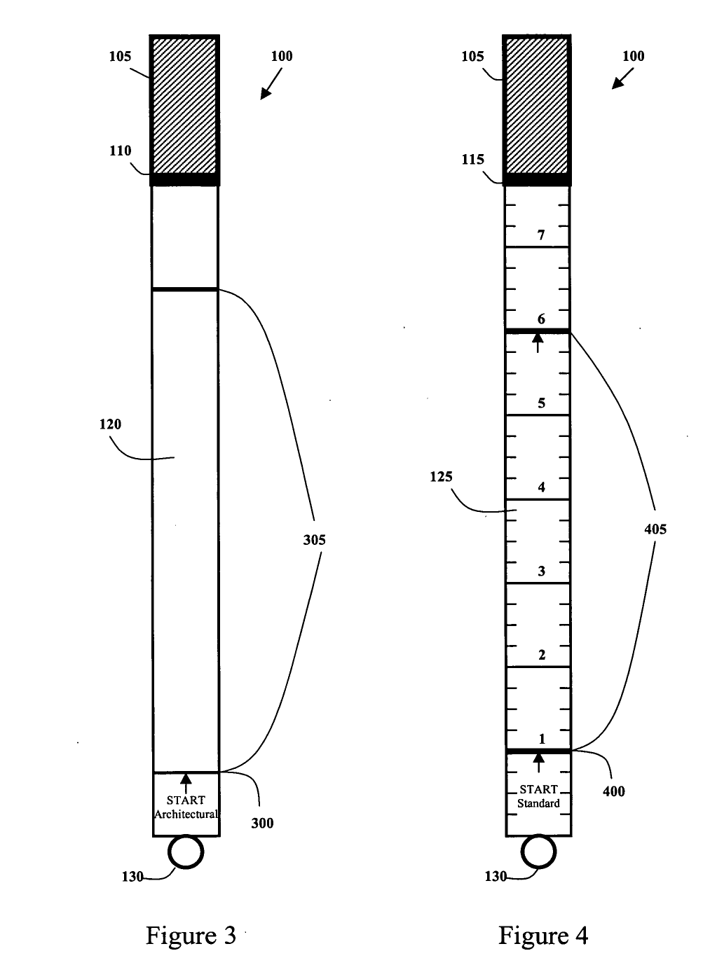

FIG. 3 is a top view of the preferred embodiment 100 with the architectural side 120 of the lay-out tape facing upward. In practice, the roofer starts near the bottom of the roof, at a defined distance from the side edge of the roof, and makes one mark on the roof approximately 12 inches from the bottom of the roof. This will be the starting point for the first row of shingles and is the only mark the roofer needs to make on the roof surface, using the present invention. The roofer then lines up the first indicator 300 on the lay-out tape with the one manual mark on the roof and tacks the eyelet 130 down to secure the position of the tape. Since architectural shingles are 13 ¼ inches long, starting the first row at 12 inches from the bottom allows for a 1 ¼ inch overhang of the first row of shingles. Of course, smaller and larger overhangs may also be used. The roofer then extends the lay-out tape up to the apex of the roof and temporarily secures the outstretched tape over the apex of the roof by sliding the stop-lock 110 down and allowing the weight of the case 105 to be pulled down the other side of the roof. Of course a hammer or other object can also be used to further secure the case 105. To insure straight rows, the case 105 should be the same defined distance away from the side edge of the roof as the eyelet 125. Each of the row indicators 305 are spaced 5 ½ inches away from others on the architectural side 120 of the tape. The roofer then repeats these steps at the opposite end of the roof with a second lay-out tape. When both tapes are in place a chalk line can be stretched and “struck” between each of the corresponding row indicators 305 to quickly produce straight lay-out lines for each row of shingles. This process is discussed further below and illustrated in FIG. 7.

FIG. 4 is a top view of the preferred embodiment 100 wherein the lay-out tape has been flipped upside-down so that the standard side 125 is facing upward. The standard side 125 of the lay-out tape is used when standard shingles are being attached to the roof. Standard sized shingles are slightly smaller than architectural shingles and the row indicators 405 on the standard side 125 of the tape are accordingly closer together, in this example the row indicators are spaced 5 inches apart. The standard side 125 of the lay-out tape is used in the same fashion as with the architectural side 120, described above. By providing the indicia for standard shingles and architectural shingles on the opposite sides of the same tape, confusion over which indicator to follow is avoided. In the preferred embodiment 100, at least one side of the tape includes standard tape measure indicia, which eliminates the need to carry around a separate standard measuring tape. In this example, the standard side 125 of the present lay-out tape 100 includes the inch, foot and other markings found on a standard measuring tape. These standard measuring tape indicia can be used to measure the desired distance from the bottom of the roof, and make the one and only hand drawn mark on the roof that is required when using the present invention.

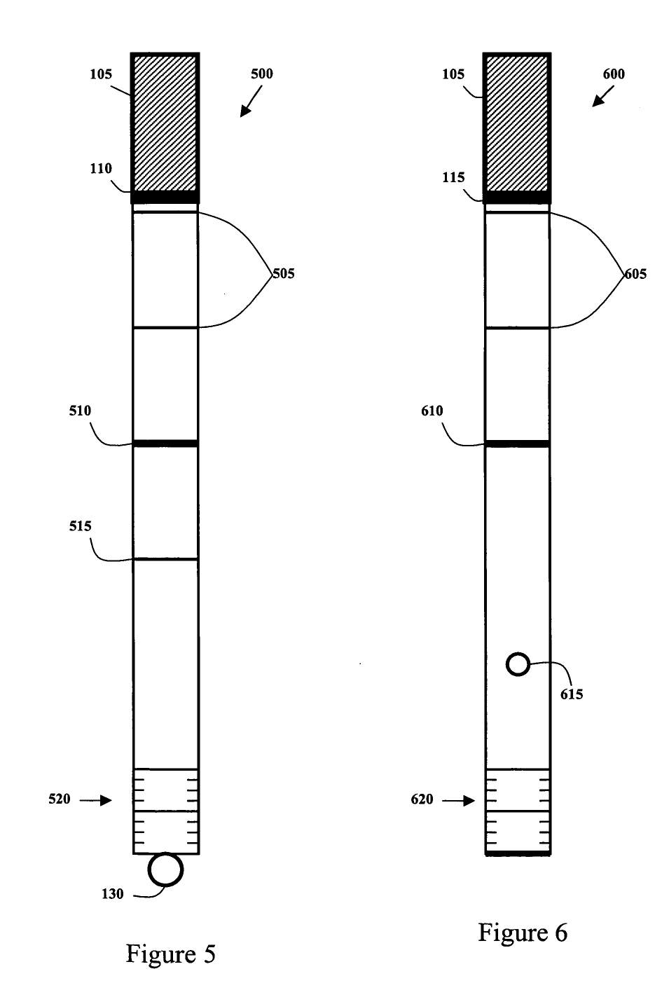

FIG. 5 is a top view of another alternative embodiment 500 with the architectural side of the tape facing up. As with the preferred embodiment, indicators for standard shingles are provided on the back side of the tape. In this embodiment 500, the first 2 inches 520 of the tape includes standard ¼ inch indicators, which allows the roofer to measure the amount of overhang of the first row of shingles. The largest indicator 510 on the tape is 13 ¼ inch away from the leading edge of the tape. After the desired amount of overhang has been measured, the roofer makes a single mark on the roof surface next to the large indicator 510 on the tape. The roofer then slides the tape up toward the apex of the roof until the first indicator 515 aligns with the single mark on the roof. The roofer then tacks the eyelet 130 to the roof to secure the tapes position and stretches out the tape to the apex of the roof. Alternative embodiment 500 is then used in the same manner as with the preferred embodiment. Each of the indicators 505, 510 & 515 on the tape are 5 1/2 inches apart from each other, and provide guides for striking chalk lines for each required row of shingles.

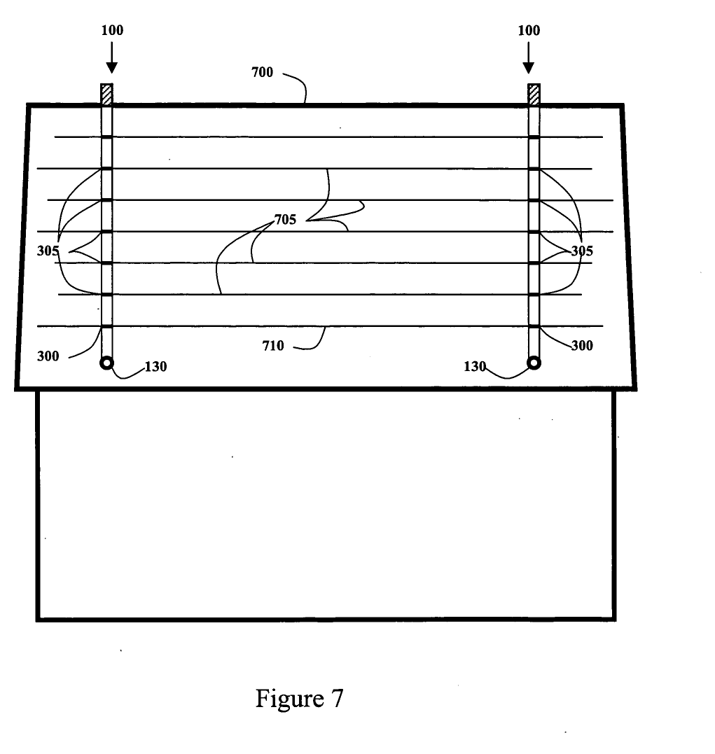

FIG. 6 is a top view of yet another alternative embodiment 600 of the present lay-out tape with the architectural side of the tape facing up. As with the preferred embodiment, indicators for standard shingles are provided on the back side of the tape. This embodiment provides the same useful purpose as the other embodiments however, this embodiment 600 can be used in fewer steps than previous embodiments. The first 2 inches 620 of the tape are calibrated with ¼ inch indicators to allow the roofer to measure the desired amount of overhang; usually 1 ¼ inches. Once the desired amount of tape is allowed to hang over the edge of the roof, the roofer immediately tacks down the tape, using eyelet 615, without the need to slide or move of the tape. The first row indicator 610 is 13 ¼ inches from the leading edge of the tape and is used to strike the chalk line for the row of shingles. Each subsequent indicator 605 is spaced 5 ½ inches apart and is used to strike subsequent chalk lines for subsequent rows of shingles. This embodiment 600 includes a traditional “L” shaped hook at the beginning of the tape to assist in pulling out the tape and to prevent the end of the tape from retracting into the case 105.

FIG. 7 shows two of the present lay-out tapes 100 in operation, on the roof 700 of a house. The first indicator 300 of each tape 100 is positioned approximately 12 inches from the bottom of the roof so that when the first row of shingles are added to the roof, the shingles will overhang the roof by approximately 1 ¼ inches. Nails are used to tack down the eyelets 130 on each tape and the tapes are then stretched over the apex of the roof. A chalk line is then stretched horizontally across the roof, using the first indicators 300 on the lay-out tapes for alignment and the first chalk line 710 is struck. This process is then repeated to strike the remaining chalk lines 705 using the remaining indicators 305 for alignment. This invention completely eliminates the time consuming and error prone requirement of having to manually pre-mark the roof surface with alignment marks.

The present lay-out tape has been shown above in several embodiments, each having their own beneficial features. Applicant acknowledges that the illustrated features could be combined in different ways to come up with even more embodiments and the figures are not intended to be limiting in any way.

The foregoing description of the specific embodiments will so fully reveal the general nature of the invention that others can, by applying current knowledge, readily modify and/or adapt for various applications such specific embodiments without departing from the generic concept. For example, spacing indicators for shingles other than architectural and standard shingles could be provided on the lay-out tape. The lay-out tape could also provide spacing indicia for other types of roofing materials, such as ceramic tiles. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A dual sided, flat lay-out tape that is adapted to assist roofers in laying out rows of shingles on a roof, wherein the lay-out tape saves time by eliminating the need for multiple manual markings and eliminates marking errors by having mark indicators for only one type of shingle on any one side of the tape, the dual sided, flat lay-out tape comprising:
a housing, the housing having a durable exterior surface that provides protection to items in an interior of the housing, wherein the housing includes a slotted opening, and at least part of a rewind mechanism is centrally located in the interior of the housing; and,
a flat ribbon, the ribbon having a first side that includes row indicator markings for a first type of roofing shingle, and a second side that includes row indicator markings for a second type of roofing shingle, wherein each set of indicator markings includes a “start” marking and indicates to the roofer where to strike chalk lines on the roof for row alignment purposes, and wherein the ribbon further includes an interior end that is attached to the rewind mechanism and an exterior end that at least partially extends outside of the opening in the housing, the exterior end of the ribbon having attached thereto an eyelet that allows the exterior end to be temporarily attached to the roof.

2. The flat lay-out tape of claim 1, wherein the first side of the ribbon further includes quarter inch, half inch and inch indicator markings along a first two inch length of the ribbon starting at the exterior end of the ribbon that assist the roofer in measuring an overhang of a first row of shingles.

3. The flat lay-out tape of claim 1, wherein the first side of the ribbon further includes standard measuring tape indicator markings that run a length of the ribbon that further-allows the roofer to use the lay-out tape for measuring purposes.

4. The flat lay-out tape of claim 1, wherein the first type of roofing shingles are architectural shingles and the second type of shingles are standard shingles.

5. The flat lay-out tape of claim 1, wherein the rewind mechanism is an automatic rewind mechanism and the housing includes at least one sliding lock that is able to lock the ribbon in place after the ribbon has been extended through the opening a desired distance.

6. The flat lay-out tape of claim 1, wherein the rewind mechanism is a hand operated mechanism and the lay-out tape includes a hand crank for reeling the ribbon back into the housing.

7. The flat lay-out tape of claim 1, wherein the housing is primarily made of a hard plastic material and the ribbon is made from a durable material, including fiberglass and metal.

8. The flat lay-out tape of claim 1, wherein the exterior end of the ribbon further includes an “L” shaped hook that prevents the exterior end of the ribbon from passing into the interior of the housing, and wherein the eyelet is located a distance from the exterior end of the ribbon.

9. A flat lay-out tape that is adapted to assist roofers in laying out rows of shingles on a roof, wherein the lay-out tape saves time by eliminating the need for multiple manual markings on the roof, and eliminates marking errors by having mark indicators for only one type of shingle on any one side of the tape, the flat lay-out tape comprising:
a housing, the housing having a durable exterior surface that provides protection to items in an interior of the housing, wherein the housing includes a slotted opening, and at least part of a rewind mechanism is centrally located in the interior of the housing; and,
a coiled ribbon that is able to lay flat against a surface when unrolled, the ribbon having a first side that includes a set of row indicator markings, including a “first row” indicator, for a first type of roofing shingle, the indicator markings being able to indicate to the roofer where to strike chalk lines on the roof for row alignment purposes, and wherein the ribbon further includes an interior end that is attached to the rewind mechanism and an exterior end that at least partially extends outside of the opening in the housing, the ribbon further having an eyelet located a distance from the exterior end, the eyelet allowing the ribbon to be temporarily attached to the roof.

10. The lay-out tape of claim 9, wherein the first row indicator is 13 ¼ inches from the exterior end of the ribbon.

11. The lay-out tape of claim 9, wherein the first side of the ribbon further includes standard measuring tape indicator markings, starting at the exterior end of the ribbon and extending at least two inches up a length of the ribbon.

12. The lay-out tape of claim 9, wherein the ribbon further includes a second side that includes a second set of row indicator markings for a second type of roofing shingle.

13. The lay-out tape of claim 9, wherein the rewind mechanism is an automatic rewind mechanism and the housing includes at least one sliding lock adjacent to the slotted opening that is able to lock the ribbon in place after the ribbon has been extended a desired distance through the opening.

14. The lay-out tape of claim 9, wherein the rewind mechanism is a hand operated mechanism and the lay-out tape includes a hand crank for reeling the ribbon back into the housing.

15. A flat lay-out tape that is adapted to assist roofers in laying out rows of shingles on a roof, wherein the lay-out tape saves time by eliminating the need for multiple manual markings on the roof, and eliminates marking errors by having mark indicators for only one type of shingle on any one side of the tape, the flat lay-out tape comprising:
a housing, the housing having a durable exterior that provides protection to items in an interior of the housing, wherein the housing includes a slotted opening, and at least part of a rewind mechanism is centrally located in the interior of the housing; and,
a coiled tape that is able to lay flat against a surface when unrolled, the tape having a first side that includes a set of row indicators, including an “initial mark” indicator and a “first row” indicator, the indicators allowing the roofer to accurately strike chalk lines on the roof for row alignment purposes, and wherein the tape further includes an interior end that is attached to the rewind mechanism and an exterior end that at least partially extends outside of the opening in the housing, the exterior end having attached thereto an eyelet that allows the tape to be temporarily attached to the roof.

16. The lay-out tape of claim 15, wherein the initial mark indicator is 13 ¼ inches from the exterior end of the tape, and the first row indicator is less than 13 inches from the exterior end of the tape.

17. The lay-out tape of claim 15, wherein the first side of the tape further includes standard measuring tape indicator markings, starting at the exterior end and extending at least two inches up a length of the tape.

18. The lay-out tape of claim 15, wherein the tape further includes a second side and the second side of the tape includes a second set of row indicators, the second set of indicators including “initial mark” and “first row” indicators, wherein the initial mark indicator is a further distance away from the exterior end of the tape than the first row indicator.

19. The lay-out tape of claim 15, wherein the rewind mechanism is an automatic rewind mechanism and the housing includes at least one sliding lock adjacent to the slotted opening that is able to lock the tape in place after the tape has been extended a desired distance through the opening.

20. The lay-out tape of claim 15, wherein the rewind mechanism is a hand operated mechanism and the housing includes a hand crank for reeling in the tape.
